(19) United States
(12) Patent Application Publication
(10) Pub. No.: US 2015/0163066 A1
(43) Pub. Date: Jun. 11, 2015

(54) TELECONFERENCING SYSTEM AND METHOD

(71) Applicant: Telefonaktiebolaget L M Ericsson (PUBL), Stockholm (SE)

(72) Inventors: Joseph DeRosa, Goshen, NY (US); Lalin Sourjah, Plano, TX (US); Gregory Rogers, Plano, TX (US); Sushil Thayappan, Plano, TX (US); Aloke Kumar Bhagat, Kolkata (IN); Lev Noryan, New York, NY (US); Cheng Qian, Plano, TX (US)

(73) Assignee: Telefonaktiebolaget L M Ericsson (PUBL), Stockholm (SE)

(21) Appl. No.: 14/098,955

(22) Filed: Dec. 6, 2013

(51) Int. Cl. H04L 12/18; H04L 29/06; H04L 12/26

(52) U.S. Cl. CPC H04L 12/1818; H04L 43/14; H04L 12/1881; H04L 65/403; H04L 65/1069

(57) ABSTRACT

A network-initiated teleconferencing system and method. In one embodiment, teleconference setup information is received pursuant to a setup request for a teleconference generated by an organizer using a messaging module. A messaging server system associated with the messaging module is monitored to obtain retrieve teleconference state information. Relative to a scheduled time, notifications are sent to personal communication devices of one or more participants (external participants, internal participants, or a combination thereof), including the organizer, for receiving consent. Upon receiving one or more consent confirmations from the one or more participants indicative of accepting a call initiated by a network, a call handling process may be invoked to initiate calls to the one or more participants for establishing the teleconference at the scheduled time.

### FIELD OF THE DISCLOSURE

The present disclosure generally relates to teleconferencing. More particularly, and not by way of any limitation, the present disclosure is directed to a system and method for effectuating teleconferencing in a network environment.

### BACKGROUND

Teleconferencing, also known as conference calling, is widely known and ubiquitously used today. Several advances such as video conferencing, Voice over IP (VoIP), Internet-based conferencing, graphics sharing, etc. have not only augmented audio conferencing but also qualitatively enhanced users' teleconferencing experience. Despite such advances, however, there is still room for improvement in the current teleconferencing technologies.

### SUMMARY

In one aspect, an embodiment of a teleconferencing method operative at an application server node is disclosed. The claimed embodiment comprises, inter alia, receiving teleconference setup information pursuant to a setup request for a teleconference generated by an organizer using a messaging module. Thereafter, a messaging server system (e.g., an email system) associated with the messaging module may be monitored to obtain or otherwise retrieve teleconference state information including at least one of scheduling information and a list of participants agreeing to attend the teleconference. Relative to a scheduled time, e.g., at or near the conference time, notifications are caused to be propagated to personal communication devices (e.g., smartphones, tablets, etc.) of one or more participants (external participants, internal participants, or a combination thereof), including the organizer. Upon receiving one or more consent confirmations from the one or more participants indicative of accepting a call initiated by a network, a call handling process may be invoked to initiate calls to the one or more participants for establishing the teleconference at the scheduled time.

In another aspect, an embodiment of a teleconferencing application server node is disclosed, for example, as a computer system having one or more processors configured to execute program code instructions stored on a non-transitory computer-readable medium for effectuating the acts set forth in the foregoing. In one implementation, the teleconferencing application server node comprises, inter alia, an event scheduler operating to receive teleconference setup information pursuant to a setup request for a teleconference generated by an organize using a messaging module. An event update receiver is provided for monitoring a messaging server system associated with the organizer's messaging module for purposes of obtaining or otherwise retrieving state information of the teleconference being schedule. In one implementation, such teleconference state information comprises scheduling information (e.g., time/day) and a list of participants (including external and/internal participants) agreeing to attend the teleconference. A notification agent is provided for causing notifications to be generated and propagated (e.g., via one or more cloud messaging notification services) to personal communication devices of one or more participants, including the organizer, relative to a scheduled time with respect to the teleconference. A consent manager is configured to receive one or more consent confirmations from the one or more participants indicative of accepting a teleconferencing call at the scheduled time. A call handler is provided for initiating calls to the one or more participants for purposes of establishing the teleconference at the scheduled time. In one example implementation, at least one of the event scheduler, event update receiver, notification agent, consent manager and the call handler may be embodied in a persistent memory coupled to the one or more processors.

In a still further aspect, an embodiment of a personal communication device is disclosed that is operative for a user to set up a network-initiated teleconference. One or more processors are coupled via appropriate bus architecture to a persistent memory that stores a plug-in module configured for operating in conjunction with a messaging module running on the device. In an example implementation, the messaging module is interoperable with a messaging server system, wherein the messaging module facilitates an interface that allows an organizer of a teleconference to input a setup request for the teleconference. The plug-in module is operative to report teleconference setup information using an event reporter to a teleconferencing application server node pursuant to the setup request input by the organizer. The plug-in module further includes a code generator for generating an authentication code corresponding to the teleconference requested by the organizer and a message injector operative to insert a teleconference application message into the setup request or meeting invitation transmitted via the messaging server system. In an example implementation, the teleconference application message or instruction may include the authentication code and a resource locator for downloading a teleconferencing client module operative with the teleconference application server node. In a further example implementation, at least one of the event reporter, authentication code generator and the message injector may be embodied in a persistent memory coupled to the one or more processors.

In still further aspects, embodiments of a non-transitory computer-readable medium containing instructions stored thereon are disclosed for performing one or more embodiments of the methods set forth herein. Additional features of the various embodiments are as recited in the dependent claims.

Advantages of the present invention include, but not limited to, reduced likelihood of missing conference calls; increased employee productivity, as there will be no waiting of participants to dial into a teleconference bridge; and improved driver safety, as the driver/participant is relieved of the distraction of having to enter various telephone numbers, authentication codes, etc. in order to take part in the teleconference while driving in a vehicle, etc. Further, the embodiments set forth below provide a more uniform operational experience to internal participants (i.e., participants within the same enterprise as the meeting organizer) and external participants (i.e., participants outside the organizer's enterprise). Additional benefits and advantages of the embodiments will be apparent in view of the following description and accompanying Figures.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1 depicts an example network environment wherein one or more teleconferencing embodiments of the present patent application may be practiced;

FIG. 2 depicts a flowchart with blocks relative to a teleconferencing method according to an embodiment;

FIG. 3 depicts an example teleconferencing flow implemented in the network architecture of FIG. 1;

FIG. 4 depicts a messaging flow diagram for scheduling a teleconference according to an embodiment of the present patent application;

FIG. 5 depicts a messaging flow diagram for initiating a teleconference call according to an embodiment of the present patent application;

FIG. 6 depicts an example enrollment flow implemented in the network architecture of FIG. 1;

FIG. 7 depicts a messaging flow diagram for enrolling a user in a network-initiated teleconference service according to an embodiment of the present patent application;

FIG. 8 is a block diagram of a computer system adapted to operate as a teleconference application server node according to an embodiment of the present patent application;

FIG. 9 depicts a flowchart with blocks relative to various steps and acts that may take place for purposes of user management according to an embodiment of the present patent application;

FIG. 10 depicts a flowchart with blocks relative to various steps and acts that may take place for purposes of consent management according to an embodiment of the present patent application;

FIG. 11 is a block diagram of a personal communication device that an organizer may use for scheduling a teleconference according to an embodiment of the present patent application;

FIG. 12 is a block diagram of a personal communication device that a user may use for providing consent for a network-initiated teleconference according to an embodiment of the present patent application; and

FIG. 13 depicts an example user interface embodiment effectuated at a user device for purposes of the present patent disclosure.

### DETAILED DESCRIPTION OF THE DRAWINGS

In the following description, numerous specific details are set forth with respect to one or more embodiments of the present patent disclosure. However, it should be understood that one or more embodiments may be practiced without such specific details. In other instances, well-known circuits, subsystems, components, structures and techniques have not been shown in detail in order not to obscure the understanding of the example embodiments. Accordingly, it will be appreciated by one skilled in the art that the embodiments of the present disclosure may be practiced without such specific components-based details. It should be further recognized that those of ordinary skill in the art, with the aid of the Detailed Description set forth herein and taking reference to the accompanying drawings, will be able to make and use one or more embodiments without undue experimentation.

Additionally, terms such as “coupled” and “connected,” along with their derivatives, may be used in the following description, claims, or both. It should be understood that these terms are not necessarily intended as synonyms for each other. “Coupled” may be used to indicate that two or more elements, which may or may not be in direct physical or electrical contact with each other, co-operate or interact with each other. “Connected” may be used to indicate the establishment of communication, i.e., a communicative relationship, between two or more elements that are coupled with each other. Further, in one or more example embodiments set forth herein, generally speaking, an element, component or module may be configured to perform a function if the element is capable of performing or otherwise structurally arranged to perform that function.

As used herein, a network element or node may be comprised of one or more pieces of service network equipment, including hardware and software that communicatively interconnects other equipment on a network (e.g., other network elements, end stations, etc.), and is adapted to host one or more applications or services with respect to a plurality of subscribers. For purposes of the present patent application, a network element may be deployed in enterprise networks, intranets, extranets, Internet service provider networks, web-based cloud platforms, telecom operator networks, and the like, and may comprise one or more combinations of the modules set forth hereinbelow for effectuating a network-initiated teleconferencing service.

One or more embodiments of the present patent disclosure may be implemented using different combinations of software, firmware, and/or hardware. Thus, one or more of the techniques and blocks shown in the Figures (e.g., flowcharts) may be implemented using code and data stored and executed on one or more electronic devices or nodes (e.g., a subscriber/user equipment (UE) device, a network element, etc.). Such electronic devices may store and communicate (internally and/or with other electronic devices over a network) code and data using computer-readable media, such as non-transitory computer-readable storage media (e.g., magnetic disks, optical disks, random access memory, read-only memory, flash memory devices, phase-change memory, etc.), transitory computer-readable transmission media (e.g., electrical, optical, acoustical or other form of propagated signals—such as carrier waves, infrared signals, digital signals), etc. In addition, such network elements may typically include a set of one or more processors coupled to one or more other components, such as one or more storage devices (e.g., non-transitory machine-readable storage media) as well as storage database(s), user input/output devices (e.g., a keyboard, a touch screen, a pointing device, and/or a display), and network connections for effectuating signaling and/or bearer media transmission. The coupling of the set of processors and other components may be typically through one or more buses and bridges (also termed as bus controllers), arranged in any known (e.g., symmetric/shared multiprocessing) or heretofore unknown architectures configured to interoperate with any Operating System (OS). Thus, the storage device or component of a given electronic device or network element may be configured to store code and/or data for execution on one or more processors of that element, node or electronic device for purposes of implementing one or more techniques of the present disclosure.

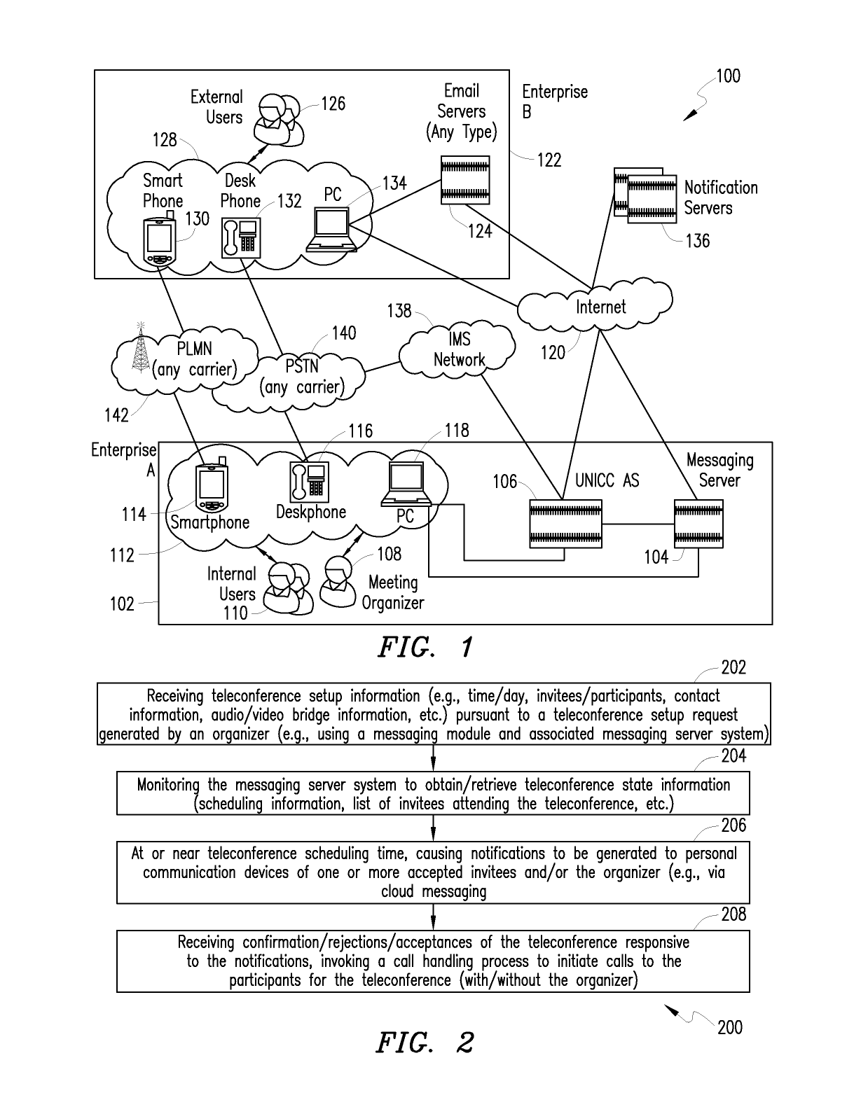

Referring now to the drawings and more particularly to FIG. 1, depicted therein is an example network environment 100 wherein one or more teleconferencing embodiments of the present patent application may be practiced. As illustrated, the example network environment 100 includes an enterprise network 102 where an organizer 108 of a teleconference meeting may be disposed in addition to one or more participants 110 internal to the enterprise network 102. A messaging server system 104 is operative to serve the enterprise network 102 for effectuating a number of communication functionalities, e.g., email, calendaring, task management and contact management, etc. In one example implementation, the messaging server system 104 may comprise a Microsoft® Exchange® Server, although other messaging/mailing systems such as IBM/Lotus Notes® and the like may also be used in other additional or alternative embodiments for purposes for the present patent disclosure. The meeting organizer 108 and internal users 110 may use any number and/or type of wired or wireless communication and/or computing devices such as mobile phones, desk phones, personal computers, laptops, tablets, etc. (generally exemplified as smartphones 114, desk phones 116 and PCs 118 in a non-limiting manner and referred to as “personal communication devices” or “PCDs” either cumulatively or in any sub-combination thereof) for effectuating internal and external communications, e.g., conferencing, sharing, emailing, messaging, telephone calls, video calls, Internet communications, and the like.

As will be described in detail hereinbelow, a teleconferencing application server node 106 may be provided in accordance with the teachings of the present disclosure for facilitating the meeting organizer 108 to set up a network-initiated teleconference that involves one or more internal users 110 as well as one or more external users 126 who may be disposed in separate enterprises (e.g., enterprise 122) having respective messaging server systems 124 or may be served otherwise (e.g., via cloud messaging applications or Internet-based email messaging applications). Similar to internal users 110, external users 126 may use any number/type of PCDs (e.g., smartphones 130, desk phones 132 and PCs 134, etc.) for effectuating various internal/external communications, including a network-initiated teleconference requested by the organizer 108. Further, a number of telecommunications infrastructures such as Public Land Mobile Networks 142, Public Switched Telephony Networks 140, IP Multimedia Subsystem (IMS) 138, cloud-based message notification systems 136 and the Internet 120 may be cooperatively utilized in conjunction with one or more information/communication technology (ICT) infrastructures associated with enterprise messaging servers and/or Internet-based messaging systems for setting up and establishing the requested network-initiated teleconference at a scheduled time under the auspices of the teleconferencing application server node 106. To facilitate such cooperative interaction, the present patent disclosure also discloses a mobile client module that may be deployed and executed at users' personal communication devices (e.g., smartphones, tablets, etc.) as well as a teleconference plug-in module that may be interfaced with a messaging module (e.g., Microsoft® Outlook®) executing at the meeting organizer's device that is operative with the messaging server system 106, as will be set forth in detail below.

For purposes of the present patent disclosure, the teleconferencing application server node 106 may be referred to as a “Universal Network-Initiated Conference Calling” (UNICC) Application Server (AS) node. In analogous fashion, the mobile client module and teleconference plug-in module operative with the UNICC AS node may be respectively termed “UNICC mobile client” and “UNICC messaging module plug-in”. It should be appreciated that whereas the overall interaction of UNICC AS node 106 with the associated plug-in and one or more UNICC mobile clients may be exemplified in a messaging architecture involving a personal information manager module such as Microsoft® Outlook® and Microsoft® Exchange® Server, example embodiments of the present disclosure described hereinbelow are not limited thereto. Further, although the example network environment 100 shown in FIG. 1 illustrates deployment of UNICC AS 106 within an enterprise network, one skilled in the art will recognize that in alternative or additional embodiments a UNICC AS node may be implemented as part of a telecom operator network or a service provider network or as an Internet-based application (e.g., as a cloud service).

A broad overview of the cooperative interaction of the various components illustrated in the example network environment 100 of FIG. 1 may now be described as follows.

Stage 1: Meeting organizer schedules a meeting through a messaging server system and associated client (e.g., Outlook®/MS Exchange® Server). The participants invited to the teleconference meeting can be internal users (within the same enterprise as the organizer) or external users (in another enterprise). In one example implementation, this meeting scheduling function may be provided as part of a standard feature set of the messaging module deployed at the organizer's device (e.g., tablet or PC).

Stage 2: The meeting scheduling activity triggers the UNICC plug-in module pre-installed on the meeting organizer's device. The plug-in transmits meeting information (scheduling time/day), participants' IDs and contact information, conference bridge information (e.g., audio and/or video bridge), etc., collectively referred to as “teleconference setup information”) to the UNICC Application Server. In one embodiment, the UNICC plug-in may also insert UNICC application-related instructions and/or messages in the meeting invitation body. In an example implementation, the instruction message(s) may be inserted mainly for users who have not enrolled into the UNICC service, and users who already downloaded and activated the UNICC mobile client may ignore the instruction message. The UNICC application-related instruction message(s) may include a brief introduction of the UNICC service feature, a web link (e.g., a Universal Resource Locator or URL) to download the UNICC mobile client and an authentication code for the user to activate its UNICC mobile client.

Stage 3: The messaging system (e.g., Outlook®/MS Exchange® Server) sends the teleconference meeting invitations to all participants, including internal users and/or external users (via associated external messaging systems).

Stage 4: UNICC Application Server maintains teleconference state. UNICC Application Server may be configured to interact with the messaging server to retrieve the list of users who have accepted the invitation as well as the scheduled time (e.g., a time settled after exercising one or more rounds of schedule (re)negotiation options such as “accept”, “decline”, “tentative”, “propose new time”, and the like by the participants including the organizer).

Stage 5: UNICC Application Server triggers notifications to the smartphones owned by the organizer and participants at a predetermined time relative to the scheduled time (e.g., at or near the scheduled meeting time). The notifications may be sent via smartphone notification servers using appropriate cloud messaging services.

Stage 6: The downloaded UNICC mobile client running on the participants' smartphones receives notifications from UNICC Application Server, displays an interface that presents various options to the participant (e.g., accept or reject the conference call). The mobile client may also allow the participants to choose which device/service to use for the teleconference (e.g., smartphone, desk phone, tablet, VoIP/SIP phone, PC, Skype-based phone etc.). Further, the mobile client may also allow the user to use a new phone number or a new device identity (e.g., a phone number not previously configured to be associated with the participant).

Stage 7: UNICC Application Server initiates a call to the meeting organizer at the scheduled time. After the organizer has accepted or provided permission to proceed without the organizer, the remaining participants that have consented to the network-initiated conference will be called based on their acceptance (i.e., consent confirmation).

Turning to FIG. 2, depicted therein is a flowchart with blocks relative to a teleconferencing method 200 according to an embodiment that may be practiced in the network environment described hereinabove. It should be appreciated that the teleconferencing method 200 may be effectuated as a computer-implemented method executing on a computer system (distributed or centralized) that may be configured to operate as the UNICC server node 106. At block 202, various pieces of teleconference setup information (e.g., time/day proposed by a meeting organizer, participants invited to the conference (i.e., invitees), contact details, audio/video bridge information, etc.) is received by or at the UNICC server pursuant to a teleconference setup request generated by the meeting organizer, for example, using a messaging module running on the organizer's personal communication device and associated messaging server system. As described in the foregoing, an example embodiment may involve a UNICC plug-in module operating at the organizer's device that is configured to interface with the UNICC server for providing such information. In another embodiment, the messaging module used by the organizer may be provided with additional features or interfaces in order to make the setup information available to any authorized/registered third-party application server designed to effectuate teleconferencing.

At block 204, the messaging system used by the organizer for setting the teleconferencing is monitored so that appropriate state information may be obtained or retrieved for maintaining and/or updating the conference state. One skilled in the art will recognize that in some instances there can be one or more rounds of negotiation taking place among the participants relative to the conference to be scheduled, e.g., in terms of proposing a new time, new agenda, addition of new invitees, deletion of prior invitees, updates of participant/device contact information, and the like, before a teleconference may be said to be finally scheduled (e.g., when no further updates are requested or required). Accordingly, the teleconferencing method 200 may involve receiving updates from the messaging system with respect to the state of a conference to be scheduled, which may be effectuated dynamically in real time as the data in the messaging system changes or at some preconfigured time intervals. Further, appropriate logic may be implemented in some configurations as to when such updates may cease or be prevented from being received by the UNICC server node. Regardless of the specific implementation, the UNICC server node may be configured to maintain a final state of the conference scheduling that involves the agreed-upon scheduled time, a list of attendees/invitees agreeing to attend the conference at the scheduled time, and the like (block 204).

Thereafter, relative to a scheduled time (e.g., at or near the agreed-upon teleconference time), appropriate notifications are caused to be generated to one or more participants (including the meeting organizer) using web-based cloud messaging services (block 206). It will be realized by one skilled in the art that such notification processes may be dependent upon the type and Operating System (OS) functionality of the participants' personal communication devices registered for receiving notifications with respect to a network-initiated conference calling service. Responsive to the notifications, one or more consent confirmations may be received by the UNICC server from the participants, which consent confirmations are operative to indicate acceptance of a call initiated by a network call handling process (block 208). Subsequently, the call handling process may be invoked at the scheduled time to initiate calls to the consenting participants for establishing the teleconference at the appropriate bridge (block 208). In one implementation, the call handling process may be invoked contingent upon determining that the meeting organizer has responded with a consent confirmation. In another implementation, the call handling process may be invoked upon determining that the meeting organizer has responded with a permission to proceed with establishing the teleconference without the organizer being on the call (i.e., without the organizer's participation). In a still further embodiment, a teleconference may be established only upon satisfying one or more conditions, e.g., when a certain number of consent confirmations have been received, receipt of consent confirmations from certain participants whose presence is deemed mandatory, etc. It should be appreciated that the foregoing list of variations is non-exhaustive and various permutations and combinations may be made as to how the invocation of a call handling process may be modulated without departing from the teachings of the present disclosure.

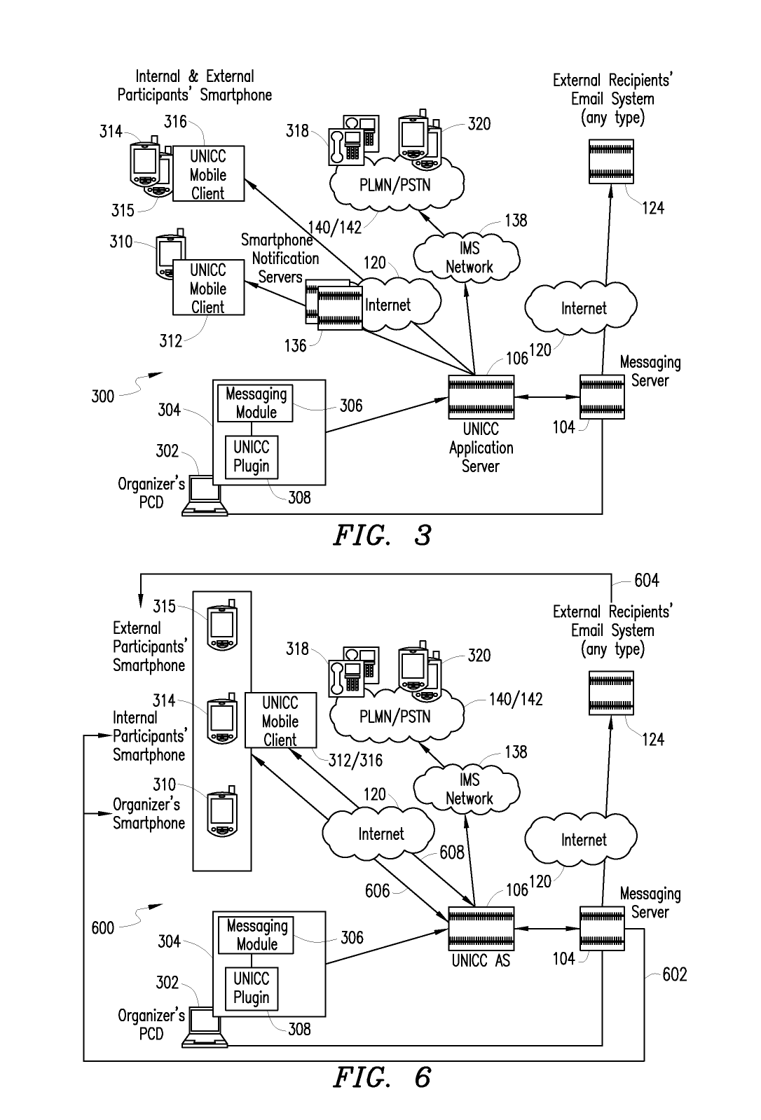

An example teleconferencing flow implemented in a network environment 300 according to an embodiment is illustrated in FIG. 3. Those skilled in the art will recognize that the network embodiment 300 is substantially identical to the example network environment 100 of FIG. 1 described hereinabove and, accordingly, some of the description of the infrastructure components is not repeated here. An organizer's PCD 302 is representative of a device that may be employed by the organizer to set up a teleconference and includes a software environment 304 comprising a messaging module 306 (e.g., Outlook®) interfaced to a UNICC plug-in or add-on module 308. In conformity with the description above, the functionality of interfacing with the organizer's messaging module 306 may be provided as a software component that adds a specific feature (or feature set) to an existing software application, e.g., a personal information management or messaging module. Such a software component may be pre-installed/loaded, pre-bundled, aftermarket installed, downloaded from a website, uploaded, or otherwise made available to be executed on the organizer's PCD 302. In general, the functionality of the organizer's UNICC plug-in module 308 is operative to collect conference call related information when the organizer sets up a teleconference using the messaging module 306 and associated messaging server system 104 by providing certain codes, e.g., a moderator code and a participant code relative to the conference being set up. Organizer's UNICC module 308 may also be configured to inject UNICC application information, instructions and messages in a meeting invitation generated by the organizer's messaging system. Reference numerals 310, 314 and 315 refer to organizer's PCD, internal participants' PCDs and external participants' PCDs, respectively, that are provided with respective UNICC mobile clients 312/316. As described previously, the mobile clients 312/316 are operative in conjunction with respective device's notification handlers for receiving and processing notifications from appropriate cloud-based notification servers 136. Reference numerals 318 and 320 refer to the actual user devices designated or otherwise identified for receiving teleconferencing calls with respect to all participants, i.e., internal/external users and the meeting organizer, who have responded to the cloud-based notifications and provided appropriate consent confirmations. It should be appreciated that there may be an overlap between the users' PCDs used for notification/consent management, and the PCDs used for actual teleconferencing, because of enhanced device capabilities as well as converges functionalities available today. Regardless, UNICC AS node 106 is operative to open the conference bridge by interacting with suitable IMS call APIs and dial all participants at the identified devices who have confirmed their respective acceptances. An example interface may be SIP over IMS Service Control (ISC) interface, which is a reference point between a Serving Call Session Control Function (S-CSCF) and the AS, whose functions may include: notify the AS of the registered identity (i.e., IP Multimedia Public Identity or IMPU), registration state and user device capabilities; supply the AS with information to allow it to execute multiple services; and convey charging function addresses.

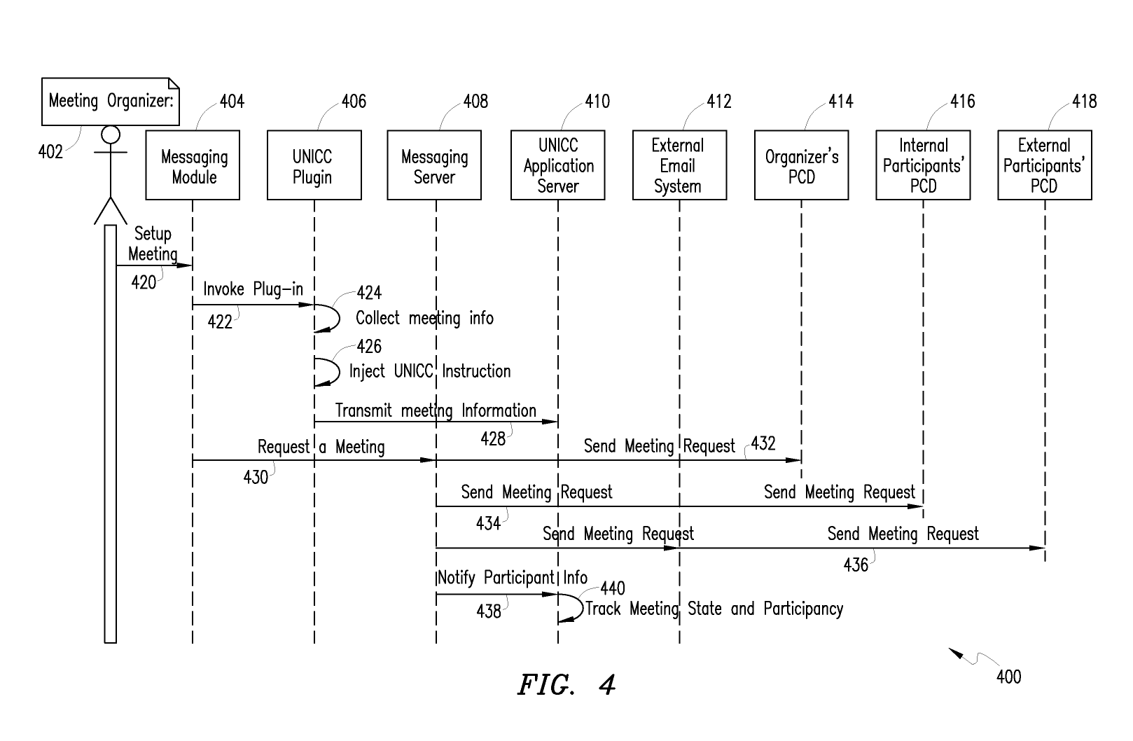

FIG. 4 depicts an example message flow sequence 400 for scheduling a teleconference according to an embodiment of the present patent application. As illustrated, a meeting organizer 402 (that may be representative of an enterprise-based organizer such as organizer 108 shown in FIG. 1) interacts with the organizer's messaging module 404 via an interface for inputting a meeting setup request 420. A UNICC plug-in module 406 is invoked at message flow 422, which collects the meeting information at message flow 424 and optionally injects suitable UNICC application instructions at message flow 426. The meeting information is also transmitted to a UNICC AS node 410 (which may be representative of an enterprise-based teleconferencing server 106 shown in FIG. 1) at flow 428. The messaging module 404 forwards the meeting request 430 to associated messaging server 408 which then sends one or more requests to organizer's PCD 414, internal participants' PCDs 416 and external participants' PCDs 418 for scheduling a teleconference at a proposed time as exemplified by message flows 432, 434 and 436, respectively. One of ordinary skill in the art will recognize that requests to external participants may be effectuated via suitable external mail/messaging systems 412 in known manner in the communication arts. The messaging server 408 is also operative to notify the participant information to the UNICC AS node 410 at message flow 438, which then tracks the conference meeting state and participant updates as shown at message flow 440.

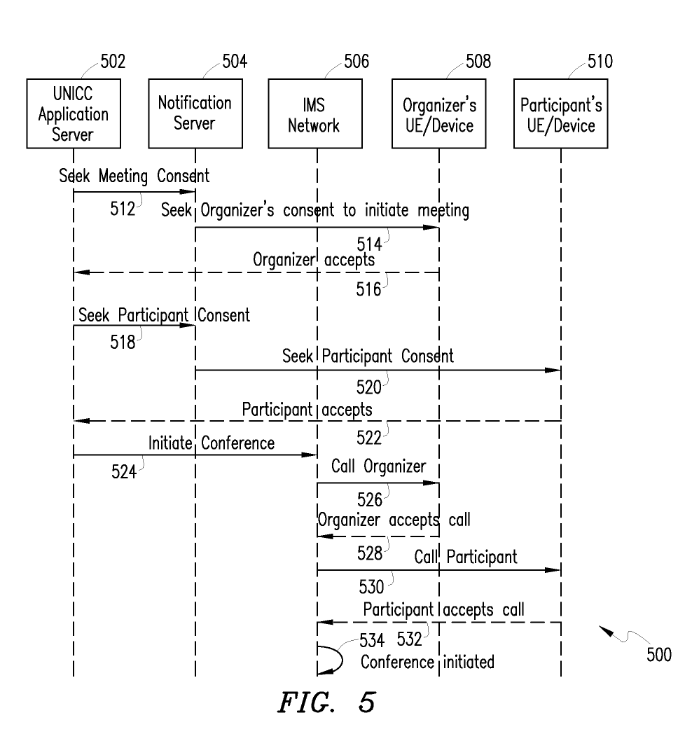

FIG. 5 depicts an example message flow sequence 500 for initiating a teleconference call according to an embodiment of the present patent application. At a scheduled time or relative thereto, a UNICC AS node 502 (which may be representative of an enterprise-based teleconferencing server 106 shown in FIG. 1) sends a message 512 to one or more notification servers 504 to seek consent confirmations relative to the scheduled teleconference. Responsive thereto, the notification server 504 sends a notification 514 to the organizer's user equipment (UE) or device (i.e., PCD) 508 designated to receive notifications. In response to the received notification, the organizer sends an acceptance confirmation (i.e., consent) to the UNICC AS node 502 as shown at message flow 516. Additional messages 518 may be generated by the UNICC AS node 502 to the notification servers 504 in order to seek consent confirmations from the other participants. Corresponding notifications 520 are accordingly propagated to the participants' UE/devices (i.e., PCDs) 510 by the notification servers 504, whereupon suitable consent confirmations 522 are provided back to the UNICC AS node 502. A call initiation message 524 is generated by the UNICC AS node 502 to the IMS network infrastructure 506, which in turn initiates suitable call setup messages to the organizer's PCD 508 as well as the confirmed participants' PCDs 510 as exemplified by message flows 526, 528, 530 and 532. As described previously, such conference call legs may be effectuated via any known PSTN/PLMN/VoIP infrastructures depending on the PCDs involved. After the call setup signaling, which in one example may be anchored at a suitable IMS network node, a multi-party bearer session for the conference may be established as shown at message flow 534.

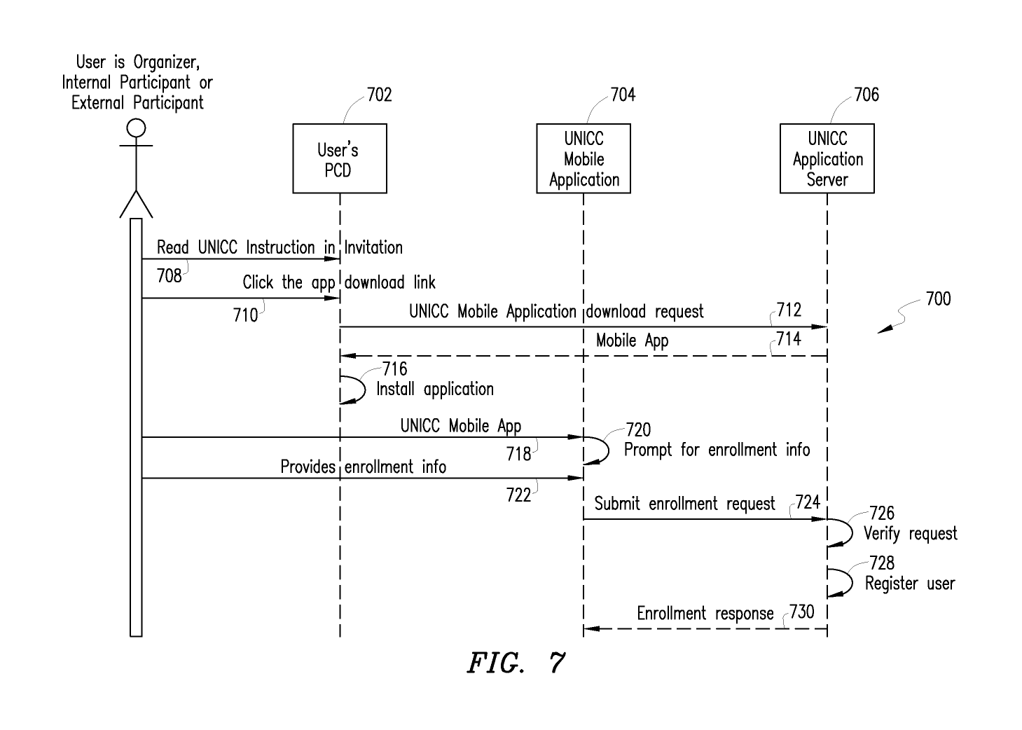

An example message flow sequence 700 associated with user enrollment is depicted in FIG. 7 wherein an organizer, external and internal participants may enroll into a UNICC service implemented in a network environment 600 of FIG. 6. As the network environment 600 shown in FIG. 6 is substantially identical to the network environments 100, 300 shown in FIGS. 1 and 3, respectively, a detailed description of the constituent components is not repeated herein, except for example invitation message paths 602, 604 generated by the organizer's messaging server 104 to the organizer's and internal users' PCDs and via external users' messaging system(s) 124 to external users PCDs. As discussed previously, the initial invitation messages may include application-specific instructions to download a service client, shown via download request paths 606 and 608 in FIG. 6. Focusing now on the message flow sequence 700 of FIG. 7, a user (i.e., the organizer, internal participant or external participant) may receive a UNICC application message/instruction 708 injected in the meeting invitations transmitted via the organizer's messaging system (and one or more external message systems, if necessary) to the users' PCDs. Upon launching suitable messaging modules at the respective PCDs, users may elect to activate (at 710) a resource locator link (e.g., a URL) provided as part of the UNICC-specific application message 708 that is inserted in the meeting invitations in order to download a mobile client or “app” relative to the UNICC service. In the example embodiment shown in FIG. 7, the download request 712 is generated to a corresponding UNICC AS node 706, although in some implementations the request(s) 712 may be operative to invoke third-party providers for purposes of downloading applicable mobile app software. Upon downloading the mobile client app(s) via message flow 714, the software 704 is installed and launched on the respective user PCDs, as exemplified by message flow 716. The mobile client app 704 may prompt the users to input certain credentials, e.g., email address and authentication code included in the meeting invitation instruction 708, as exemplified by message flow 720. In certain embodiments, the mobile client app may also provide an interface to enable the user to input identity information (e.g., E.164 numbers, URIs, IMPUs, etc.) of one or more devices on which the user wants to receive a teleconferencing call. As a further variation, where there is a list of devices, such a list of devices may also be prioritized in terms of user preference. Responsive to the prompt 720, users may provide appropriate enrollment information 722, whereupon the mobile client 704 submits an enrollment request 724 to the appropriate UNICC AS node 706. After a request verification process 726 and user registration process 728 at the UNICC AS node 706, an enrollment response 730, including, e.g., a successful enrollment notification, may be caused to be transmitted to the users' PCDs via suitable means (e.g., cloud messaging).

FIG. 8 is a block diagram of a computer system adapted to operate as a UNICC application server node 800 according to an embodiment of the present patent application. Illustratively, one or more processors 802 are provided for effectuating the overall control of the UNICC AS node 800 under suitable program code instructions (e.g., an Operating System, not explicitly shown) as well as application-specific software for effectuating network-initiated teleconferencing. Memory 804 and appropriate input/output (I/O) interfaces 806 may be operatively coupled to the processors 802 via suitable bus architecture, wherein memory 804 is representative of various types of volatile and nonvolatile (i.e., persistent) memory and I/O interfaces 806 are representative of interfaces operative to effectuate network connectivity to a plurality of entities via wireless or wired communications. By way of illustration with respect to one or more modules constituting the teleconferencing application software, which may be embodied in one or more partitioned blocks of persistent memory 850, such interfaces may comprise a web service over HTTP interface 830 for connecting to a UNICC plug-in 828, an HTTP interface 834 for connecting to a smartphone/PCD 832, a web service over HTTP interface 838 for connecting to a UNICC mobile client 836, a web service over HTTP interface 842 for connecting to a messaging server 840, a SIP interface 844 for connecting to an IMS network 842, and a web service over HTTP interface 848 for connecting to one or more notification servers 846.

For purposes of the present patent application, a web service may broadly be defined as a software system designed to support interoperable machine-to-machine (M2M) interactions over a network using, for example, an interface described in a machine-processable format such as a Markup Language-based interface description language (for instance, Web Service Definition Language or WSDL). Other systems may interact with the web service in a manner prescribed by its description using Simple Object Access Protocol (SOAP) messages, typically conveyed using HTTP with an XML serialization in conjunction with other web-related standards. Another alternative of a web service implementation may comprise a Representational State Transfer (REST)-based web service, which is generally considered to be a simpler alternative to SOAP-based implementations.

Various modules and components relative to effectuating the UNICC AS functionality will now be described immediately below, although it should be understood by one skilled in the art that not all modules or components are deemed necessary to practice an embodiment of the present patent disclosure.

An event scheduler 810 is operative to receive new meeting/teleconference events related information, including the organizer email address, participants' email addresses, meeting start time, meeting stop time and UNICC authentication code, from the UNICC Outlook Plug-in via web service over HTTP protocol interface 830. The event scheduler 810 is also configured to store the event information in a suitable database structure such as, e.g., event repository 822. Further, the event scheduler 810 may be configured to provide a suitable timer function that tracks when the meeting event will occur and trigger a notification agent 820 to notify the participants before the meeting event start time. An event update receiver 816 is operative to interface with the messaging server 840 via web service over HTTP protocol interface 842 for monitoring and tracking conference state information thereat. Accordingly, the update receiver 816 may be configured to receive appropriate updates and other inputs from the meeting organizer's messaging server 840 related to the scheduled events, which updates/inputs may comprise information regarding (i) new added participants because, for example, the meeting invitation has been forwarded or otherwise extended to additional participants, (ii) one or more previous invitees have been deleted, and (iii) scheduling negotiation interactions among the participants (e.g., accept/reject/deny/counter-propose responses), etc. The event update receiver 816 may also be configured to store the updated meeting information into the event repository 822.

A user management module 814 is operative to receive enrollment request information from UNICC mobile client(s) 836 via web service over HTTP interface 838. As described previously, such enrollment request information may include user's email, UNICC authentication code, user PCD type (e.g., smartphone type and capabilities), and user notification identifier. The user management module 814 may be configured to query valid UNICC authentication codes from the event repository 822 based on participant's email address and allowed time windows (e.g., 24 hours, 48 hours, etc.) before the received enrollment request time. The user management module 814 may also verify the received enrollment requests against all valid UNICC authentication codes and may be configured to add user information into a suitable database such as a user repository 824. The notification agent 820 is operative to interface with cloud-based notification servers 846 via web service over HTTP interface 848 and may be configured to retrieve user's PCD/smartphone type and notification identifier information from the user repository 824. Based on the retrieved information, the notification agent 820 may select a particular destination notification server depending at least in part upon the user's PCD/smartphone type. Thereafter, the notification agent 820 may cause a consent-seeking notification to the UNICC mobile clients running on the participants' devices. A consent manager module 826 is operative to receive consent responses (for example, including, but not limited to, confirmations, rejections, device redirections, etc.) from the participants' UNICC mobile clients. Broadly, the consent response may at least be configured to indicate whether the user want to accept a call from the network or not. In certain implementations, the consent response may also include the preferred device ID (e.g., phone number), on/from which the user wants to receive a call. If the user has allowed a call from the network, the consent manager module 826 is operative to invoke a call handling component 818 to initiate a call. In one example implementation, the call handler 818 may be configured to Interact with the IMS network 842 via SIP protocol interface 844 to initiate a call to the teleconference audio/video bridge node, which can be an enterprise-based server that can receive and route a large number of calls at the same time. Additionally or alternatively, the call handler 818 may interface with a bridge hosted by a third-party conferencing site. Regardless of how a conference bridge is deployed, appropriate call sessions may be effectuated through telecommunications infrastructure, including PSTN, PLMN and VoIP infrastructures. Accordingly, the call handler 818 may interact with the IMS network 842 to initiate calls to the meeting organizer if the organizer has given consent to the UNICC system as well as to the consenting participants who have appropriately responded to the system.

A download server component 812 may also be provided as part of the example UNICC server 800 for facilitating transfer of mobile client/app software to authorized user devices. In general, the download server component 812 is operative to detect the requesting PCDs' Operating Systems by checking the metadata in the HTTP requests received over the interface 834, which HTTP requests usually indicate the browser agent type used by the PCDs (including smartphones, tablets, palmtops, handhelds, smart PDAs, etc.). Depending upon the PCD type/capabilities, different copies/versions/updates of mobile client software may be provided. Additionally or alternatively, the download server component 812 may redirect the download requests to third-party websites, e.g., application downloading platforms supported by PCD vendors, telco service operators, Internet Service Providers (ISPs), Application Service Providers (ASPS), etc.

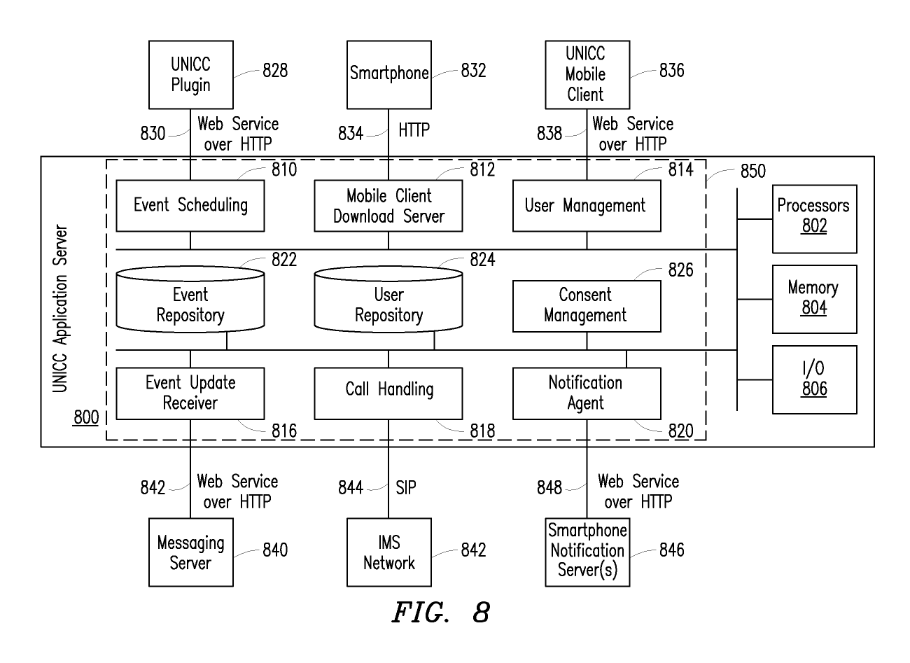

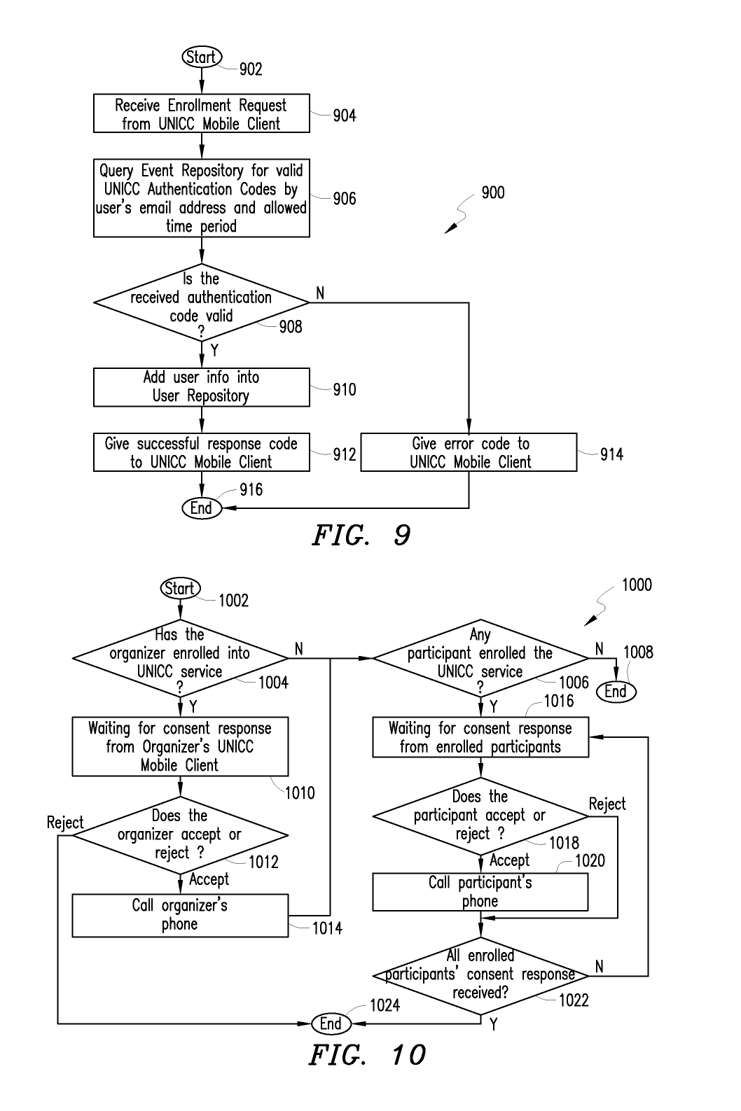

Taking reference to FIG. 9, depicted therein is a flowchart with blocks relative to various steps and acts that may take place to effectuate a user management scheme 900 by the user manager 814 according to an embodiment of the present patent application. Upon starting of the process (block 902), an enrollment request may be received from a UNICC mobile client (block 904). A database (e.g., event repository 822) may be queried, e.g., based on the user's email address, for valid UNICC authentication code and allowed time period (block 906). If the received authentication code is determined valid (e.g., matches the stored data), the user information is added to the repository (block 910). Subsequently, a successful response code may be provided to the UNICC mobile client (block 912). If the received authentication code is not valid, an error code may be generated and subsequently propagated to the UNICC mobile client (block 914), whereupon the user management scheme 900 is completed (block 916).

FIG. 10 depicts a flowchart with blocks relative to various steps and acts that may take place for purposes of a consent management scheme 1000 according to an embodiment of the present patent application. Upon starting of the process (block 1002), a determination may be made as to whether a meeting organizer has enrolled in the UNICC service (block 1004). If so, the process waits for a consent response to be received from the organizer's mobile client (block 1010). If the consent response from the organizer is an “accept” (as determined at block 1012), the organizer's designated PCD (e.g., a mobile phone) is called (block 1014). On the other hand, in the particular embodiment shown in FIG. 10, if the enrolled organizer's response is a “reject” at decision block 1012, the process flow ends (block 1024) regardless of whether there are any other participants.

If the organizer has consented or a determination has been made (at block 1004) that the organizer has not enrolled into the UNICC service, the process 1000 flows to a decision block 1006 where a further determination may be made as to whether any participants have enrolled in to the UNICC service. If so, the process waits for a consent response to be received from the enrolled participants' mobile clients (block 1016). Otherwise, the process flow ends (block 1008). With respect to the enrolled participants, a control loop may be executed until all enrollees have responded with either “accept” or “reject” responses, as exemplified by the logic shown at blocks 1018, 1020 and 1022. After receiving consent responses from all enrolled participants, the process flow ends (block 1024).

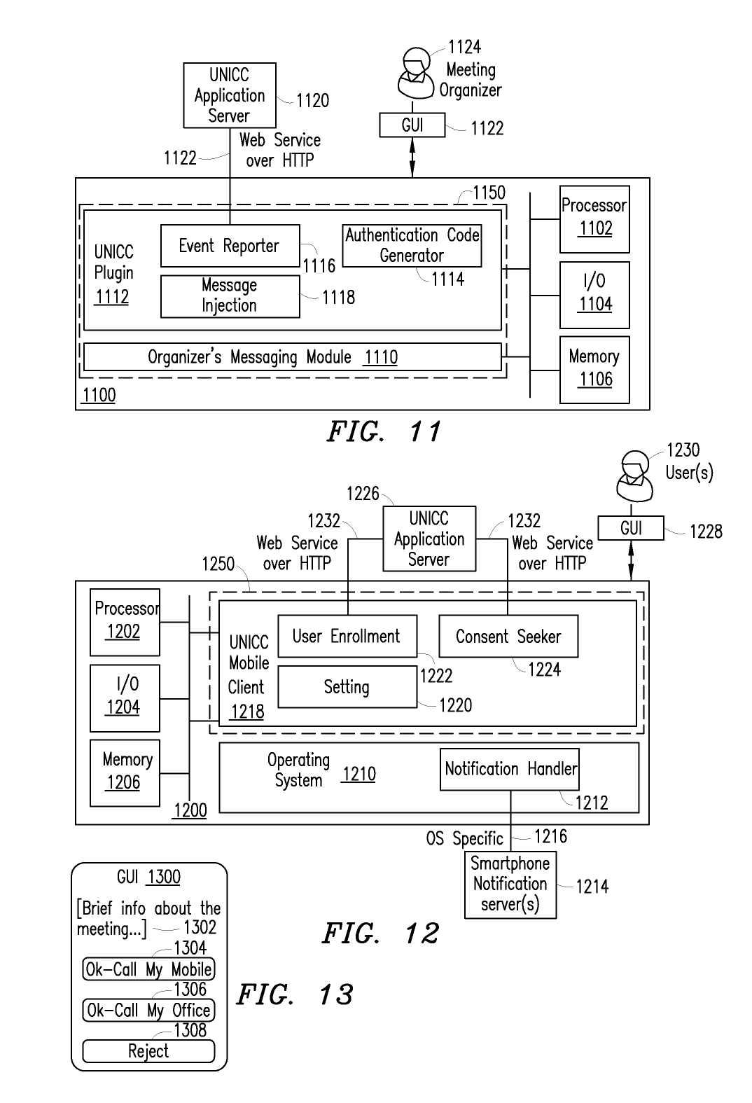

FIG. 11 is a block diagram of a computer system adapted to operate as a personal communication device 1100 (e.g., a personal computer, laptop computer, tablet, smartphone, etc.) that an organizer may use for scheduling a teleconference according to an embodiment of the present patent application. By way of illustration, one or more processors 1102 are provided for effectuating the overall control of PCD 1100 under suitable program code instructions (e.g., an Operating System, not explicitly shown) as well as suitable application software including a messaging module 1110 interfaced to a UNICC plug-in module 1112. Memory 1106 and appropriate I/O interfaces 1104 may be operatively coupled to the processors 1102 via suitable bus architecture, wherein memory 1106 is representative of various types of volatile and nonvolatile (i.e., persistent) memory and I/O interfaces 1104 are representative of interfaces operative to effectuate network connectivity to a plurality of entities via wireless or wired communications. By way of illustration with respect to one or more modules constituting the UNICC plug-in software, which may be embodied in one or more partitioned blocks of persistent memory 1150, an example interface may comprise a web service over HTTP interface 1122 for connecting to a UNICC AS node 1120. A meeting organizer 1124 may schedule a teleconference meeting using the messaging module 1110, for example, by inputting appropriate data via a user interface 1122 associated with a calendaring application of the messaging module 1110. The UNICC plug-in 1112 may be launched by clicking on a button or other means operating in conjunction with the messaging module 1110. When activated, various components of the UNICC plug-in module 1112 may be executed, though not necessarily at the same time, for interacting with the messaging module 1110 on one side and the UNICC AS node 1120 on the other. A message injector module 1118 is operative to insert a teleconference application message and/or instructions into the organizer's meeting request/invitation request, including a text message describing the UNICC service feature, a URL to downloadable mobile client software as well as an authentication code for the user to enroll into the UNICC service. A code generator 1114 is operative to generate an authentication code (e.g., a one-time PIN number such as an 8-digit random number) that is specific to the conference being scheduled by the organizer 1124. An event reporter 1116 is provided for interfacing with the UNICC AS node 1120, and may be configured to report the setup information to the server via interface 1122 before the teleconference meeting invitation is transmitted to the associated messaging server system.

FIG. 12 is a block diagram of a computer system adapted to operate as a personal communication device 1200 (e.g., smartphone, tablet, etc.) that a user may use for providing consent with respect to a network-initiated teleconference in accordance with an embodiment of the present patent application. As illustrated, one or more processors 1202 are provided for effectuating the overall control of PCD 1200 under suitable program code instructions (e.g., an Operating System 1210) as well as suitable client application software including a UNICC mobile client 1218, for example. Memory 1206 (volatile and nonvolatile (i.e., persistent) memory) and appropriate I/O interfaces 1204 may be operatively coupled to the processors 1202 via suitable bus architecture, wherein I/O interfaces 1204 are representative of interfaces operative to effectuate network connectivity to a plurality of entities via wireless or wired communications. By way of illustration with respect to one or more modules constituting the UNICC mobile client software, which may be embodied in one or more partitioned blocks of persistent memory 1250, an example interface may comprise one or more web service over HTTP interfaces 1232 for connecting to a UN ICC AS node 1226.

As the participants may use various types of PCDs, a specific version of UNICC mobile client 1218 that is compatible with the PCD's OS 1210 needs to be installed. After an appropriate version of the client software is downloaded and installed, users 1230 can open the mobile client 1218 to start the process of service enrollment. In a typical implementation, the client software depends on the notification handler service 1212 provided by the OS vendors to instantiate the enrollment function properly. Upon receiving a notification from the notification server 1214 via OS-specific interface(s) 1216, OS 1210 may be configured to wake up the client application per the instruction included in the notification and pass the notification message to the destination mobile application. In an example embodiment, the UNICC mobile client 1218 may include the following components. A user enrollment module 1222 is operative to allow the user to submit the information required by UNICC AS node 1226 to enroll into the UNICC service via web service over HTTP interface 1232. A consent seeker module 1224 may be configured to receive a notification caused by the UNICC AS node 1226 at a predetermined time relative to every scheduled meeting (e.g., a select time period prior to the meeting). As described previously, the notification message may be delivered through the notification handler service 1212 provided as part of OS 1210. Responsive thereto, a user interface may be displayed via GUI 1228 to the user 1230 (e.g., the meeting organizer, external or internal participants) for allowing appropriate consent response input, which may be propagated to the UNICC AS node 1226 via web service over HTTP interface 1232. A setting module 1220 may be provided that is operative to facilitate a device configuration interface wherein users may set or configure different devices and IDs used for teleconferencing.

FIG. 13 depicts an example display window 1300 effectuated at a user device (e.g., PCD 1200 described above) according to an embodiment for purposes of providing consent response. A brief introductory textual piece 1302 containing information about the meeting may be presented either as part of an initial menu or in a separate drop down menu selection. Additional menu options may include one or more Accept options 1304, 1306 that specify different or destinations or PCDs, e.g., mobile phone, office desk phone, etc. A Reject button 1308 is provided to allow a user to indicate to the UNICC server that the user does not want to receive a network-initiated teleconference call.

Based upon the foregoing Detailed Description, it should be appreciated that the embodiments of the present disclosure can be advantageously deployed to overcome various shortcomings of the existing teleconferencing technologies. For example, by removing the need for manual intervention required to join/initiate a teleconference bridge, the likelihood of missing conference calls can be significantly reduced. Also, existing IT and teleconferencing/scheduling tools can be beneficially leveraged and value-added by implementing a network-initiated conferencing system as disclosed herein without having to retool the ICT infrastructure in a significant manner. The embodiments herein further extend and improve teleconferencing experience to users outside one's enterprise (e.g., suppliers, customers or partners, and the like), thereby improving overall productivity of an organization.

One skilled in the art will recognize that although certain embodiments have been described in the context of an enterprise-based messaging system, the teachings of the present patent disclosure are not necessarily limited thereto. For example, some network-initiated teleconferencing implementations may involve host-based and/or cloud-based messaging systems. In another variation, the functionality of network-initiated teleconferencing may also be deployed as a cloud-based application service. In a still further variation, enrollment into a network-initiated teleconferencing service may be decoupled from the scheduling process of a user's messaging system, for example, by allowing a user to download appropriate client software to subscribe to the service before being invited to a particular teleconference. In such a scenario, the need for injecting application-specific messages, download links, etc. in the messaging system's scheduling invitations may be obviated. It is further envisaged that in certain additional embodiments, a separate notification mechanism to obtain the device information (i.e., where the users would like to receive the teleconference calls) may be eliminated, e.g., by allowing the users to provide such information at the time of acceptance of meeting invitations during the initial scheduling effectuated via the messaging system. In a still further variation, the call handling process of a UNICC AS node may be decoupled and deployed as a separate node and/or as a third-party service.

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and may not be interpreted in an idealized or overly formal sense expressly so defined herein.

At least some example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. Such computer program instructions may be provided to a processor circuit of a general purpose computer circuit, special purpose computer circuit, and/or other programmable data processing circuit to produce a machine, so that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). Additionally, the computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

As alluded to previously, tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray). The computer program instructions may also be loaded onto or otherwise downloaded to a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

Further, in at least some additional or alternative implementations, the functions/acts described in the blocks may occur out of the order shown in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Moreover, the acts, steps, functions, components or blocks illustrated in a particular flowchart may be inter-mixed or otherwise inter-arranged with the acts, steps, functions, components or blocks illustrated in another flowchart in order to effectuate additional variations, modifications and configurations with respect to one or more implementations for purposes of the present patent disclosure. Moreover, other blocks may be added/inserted between the blocks that are illustrated. Finally, although some of the diagrams include arrows on communication paths to show a primary direction of communication, it is to be understood that communication may occur in the opposite direction relative to the depicted arrows.

Although various embodiments have been shown and described in detail, the claims are not limited to any particular embodiment or example. None of the above Detailed Description should be read as implying that any particular component, element, step, act, or function is essential such that it must be included in the scope of the claims. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

What is claimed is:

1. A teleconferencing method operative at an application server node, the method comprising:
receiving teleconference setup information pursuant to a setup request for a teleconference generated by an organizer using a messaging module;
monitoring a messaging server system associated with the messaging module to obtain teleconference state information including at least one of scheduling information and a list of participants agreeing to attend the teleconference;
causing notifications to be generated, relative to a scheduled time, to personal communication devices of one or more participants including the organizer;
receiving one or more consent confirmations from the one or more participants indicative of accepting a call initiated by a network call handling process; and
invoking the network call handling process to initiate calls to the one or more participants for establishing the teleconference at the scheduled time.

2. The method as recited in claim 1, the notifications are caused to be generated using one or more cloud messaging services.

3. The method as recited in claim 1, wherein the teleconference setup information comprises at least one of a proposed teleconference time, contact information of one or more participants including the organizer and teleconference bridge information.

4. The method as recited in claim 3, wherein the teleconference bridge information includes at least one of audio conferencing bridge information and video conferencing bridge information.

5. The method as recited in claim 1, wherein a consent confirmation from a particular participant includes identity information of a device on which the particular participant wants to receive the call for teleconferencing.

6. The method as recited in claim 1, wherein the network call handling process is invoked upon determining that the organizer has responded with a consent confirmation responsive to the notification from a cloud messaging service.

7. The method as recited in claim 1, wherein the network call handling process is invoked upon determining that the organizer has responded with a permission, responsive to the notification from a cloud messaging service, to proceed with establishing the teleconference without the organizer's participation.

8. A teleconferencing application server node, comprising:
one or more processors;
an event scheduler operating to receive teleconference setup information pursuant to a setup request for a teleconference generated by an organize using a messaging module;
an event update receiver operating to monitor a messaging server system associated with the organizer's messaging module for obtaining teleconference state information including at least one of scheduling information and a list of participants agreeing to attend the teleconference;
a notification agent configured to cause notifications to be generated to personal communication devices of one or more participants including the organizer, the notification agent operating relative to a scheduled time with respect to the teleconference;
a consent manager configured to receive one or more consent confirmations from the one or more participants indicative of accepting a teleconferencing call at the scheduled time; and
a call handler configured to initiate calls to the one or more participants for establishing the teleconference at the scheduled time,
wherein at least one of the event scheduler, event update receiver, notification agent, consent manager and the call handler is embodied in a persistent memory coupled to the one or more processors.

9. The teleconferencing application server node as recited in claim 8, the notification agent is further configured to cause the notifications to be generated using one or more cloud messaging services.

10. The teleconferencing application server node as recited in claim 8, wherein the teleconference setup information comprises at least one of a proposed teleconference time, contact information of one or more participants including the organizer and teleconference bridge information.

11. The teleconferencing application server node as recited in claim 10, wherein the teleconference bridge information includes at least one of audio conferencing bridge information and video conferencing bridge information.

12. The teleconferencing application server node as recited in claim 8, wherein a consent confirmation from a particular participant includes identity information of a device on which the particular participant wants to receive the call for teleconferencing.

13. The teleconferencing application server node as recited in claim 8, wherein the call handler is invoked responsive to determining that the organizer has responded with a consent confirmation responsive to the notification from a cloud messaging service.

14. The teleconferencing application server node as recited in claim 8, wherein the call handler is invoked upon determining that the organizer has responded with a permission, responsive to the notification from a cloud messaging service, to proceed with establishing the teleconference without the organizer's participation.

15. The teleconferencing application server node as recited in claim 8, further comprising:
an event repository for storing teleconference setup information and teleconference state information pertaining to a plurality of teleconferences requested using the messaging server system and monitored by the event update receiver;
a user repository for storing user information from users that have downloaded a teleconferencing client module operative with the teleconference application server node, wherein the teleconferencing client module is configured to allow a user to subscribe to a teleconferencing service effectuated by the teleconferencing application server node and to facilitate an interface at a user's personal communication device for inputting a consent confirmation relative to a scheduled teleconference accepted by the user; and
a download server component configured to provide the teleconferencing client module to one or more users that have responded to a query provided in a teleconference setup request transmitted via the messaging server system.

16. A non-transitory computer-readable medium containing instructions stored thereon which, when executed by a computer system configured to operate as a teleconferencing application server node coupled to an enterprise messaging system, effectuate a network-initiated conferencing calling process, the computer-readable medium comprising:
a code portion for processing teleconference setup information received pursuant to a setup request for a teleconference generated by an organizer using a messaging module that is associated with the enterprise messaging system;
a code portion for monitoring the enterprise messaging system to obtain teleconference state information including at least one of scheduling information and a list of participants agreeing to attend the teleconference;
a code portion for causing notifications to be generated, relative to a scheduled time, to personal communication devices of one or more participants including the organizer;
a code portion for processing one or more consent confirmations received from the one or more participants indicative of accepting a call initiated by a network call handling process; and
a code portion for invoking the network call handling process to initiate calls to the one or more participants for establishing the teleconference at the scheduled time.

17. A device, comprising:
one or more processors;
a messaging module operative with a messaging server system, the messaging module for facilitating an interface that allows an organizer of a teleconference to input a setup request for the teleconference; and
a plug-in module interfacing with the messaging module and operative to report teleconference setup information using an event reporter to a teleconferencing application server node pursuant to the setup request input by the organizer,
a plug-in module further including:
a code generator for generating an authentication code corresponding to the teleconference requested by the organizer; and
a message injector operative to insert a teleconference application message into the setup request transmitted via the messaging server system, wherein the teleconference application message includes the authentication code and a resource locator for downloading a teleconferencing client module operative with the teleconference application server node,
wherein at least one of the event reporter, authentication code generator and the message injector is embodied in a persistent memory coupled to the one or more processors.

18. The device as recited in claim 17, wherein the resource locator is a web link operative to download the teleconferencing client module that is configured to allow a user to subscribe to a teleconferencing service effectuated by the teleconferencing application server node and to facilitate an interface at a user's personal communication device for inputting a consent confirmation relative to a scheduled teleconference accepted by the user.

19. The device as recited in claim 17, wherein the teleconference setup information comprises at least one of a proposed teleconference time, contact information of one or more participants including the organizer and teleconference bridge information.

20. The device as recited in claim 19, wherein the teleconference bridge information includes at least one of audio conferencing bridge information and video conferencing bridge information.
